(19) United States
(12) Patent Application Publication
(10) Pub. No.: US 2009/0162517 A1
(43) Pub. Date: Jun. 25, 2009

(54) Chilled Nutritional Emulsions

(76) Inventors: Chron-Si Lai, Blacklick, OH (US); Joseph E. Walton, Westerville, OH (US); Jim-Wen R. Liu, Dublin, OH (US); Kati E. Shearer, Muscle Shoals, AL (US); Emily A. Stepp, Gahanna, OH (US); Terry B. Mazer, New Albany, OH (US)

Correspondence Address: ROSS PRODUCTS DIVISION OF ABBOTT LABORATORIES;DEPARTMENT 108140-DS/1, 625 CLEVELAND AVENUE, COLUMBUS, OH, 43215-1724, US

(21) Appl. No.: 11/962,198

(22) Filed: Dec. 21, 2007

(51) Int. Cl. A23C 9/152; A23L 1/035

(52) U.S. Cl. 426/580; 426/590

(57) ABSTRACT

Disclosed are nutritional emulsions comprising fat, protein and carbohydrate. The emulsions include a V-complex or aqueous phase comprising a food grade surfactant complexed with a polydextrose having an average degree of polymerization of at least about 10; wherein the nutritional emulsion has a first viscosity at 20° C. of less than about 300 cps and a second viscosity at a temperature of from 0° C. to 8° C. that is at least about 50 cps higher than said first viscosity. Also disclosed is a process for the making the nutritional emulsion. The nutritional emulsions develop a surprisingly thick, creamy texture when chilled prior to use.

### FIELD OF THE INVENTION

The present invention relates to chilled nutritional emulsions, and methods of making them, having improved viscosity and mouthfeel characteristics.

### BACKGROUND OF THE INVENTION

There are many nutritional beverages that are commercially available today, and still more yet that are not readily available to consumers but are described in the literature or otherwise well known in the nutritional beverage art. These beverages typically contain combinations of fat, protein, carbohydrate, vitamins, and minerals, often as part of a milk-based emulsion.

Some of these nutritional beverages contain reduced caloric densities to thus provide a low calorie food product for use in helping to maintain a healthy body weight. These low calorie formulas often contain reduced fat concentrations, which can have an undesirably thin or watery texture unless additional ingredients are added to affect product viscosity.

One method for increasing the viscosity of nutritional emulsions, especially low fat or low calorie beverages, is to formulate with soluble fibers or materials rich in such fibers. These soluble fibers are typically in the form of indigestible soluble fibers such as alginates, carrageenan, agar, pectin, guar gum, Xanthan, beta-glucan, and so forth, all of which have gelling or water-retention characteristics that ultimately increase product viscosities. These soluble fibers, however, can make processing more difficult, especially since the higher resulting viscosity also requires a longer and more severe sterilization process to produce an acceptable level of heat penetration. The use of severe heat treatment during sterilization may result in an increase in the production of Maillard reaction products that may affect the color and flavor of the beverage and may, therefore, decrease the general sensory acceptance of the beverage. The use of a high level of soluble fibers may also actually destabilize emulsions and impart a slimy mouthfeel to the beverage.

Yet another method for increasing the viscosity of nutritional emulsions, including low fat or low calorie beverages, is to formulate with corn or other similar other starches. However, the ability of starch to impart viscosity depends on the survival of their inherent granular structure in an aqueous system and its concentration therein. Because of the many variables associated with emulsion processing, including various heating and shearing steps it is difficult to maintain the granular structure of the starch and thus control the viscosity of the resulting emulsion. And like soluble fiber, starch itself can also make processing more difficult, especially since the higher resulting viscosity also requires a longer and more severe sterilization process to produce an acceptable level of heat penetration.

And finally, although there may be low fat or low calorie nutritional emulsions from the prior art that have been formulated with relatively high viscosities, such higher viscosities will not completely mask or make up for the thin or watery mouthfeel associated with a reduced fat content. In other words, the nutritional emulsion may have a desirable viscosity, but it will not typically have the creamy mouthfeel normally associated with higher fat levels.

There is therefore a need for novel nutritional liquids, especially low fat or low calorie products, that have both a desirable viscosity and a creamy mouthfeel akin to that of a higher fat formulation.

### SUMMARY OF THE INVENTION

A first embodiment of the present invention is a nutritional emulsion comprising fat, protein and carbohydrate, including a V-complex comprising a food grade surfactant complexed with a polydextrose having an average degree of polymerization of at least about 10, wherein the nutritional emulsion has a first viscosity at 20° C. of less than about 300 cps and a second viscosity at a temperature of from 0° C. to 8° C. that is at least about 50 cps higher than the first viscosity.

A second embodiment of the present invention is a nutritional emulsion comprising fat, protein and carbohydrate, including an aqueous phase comprising a food grade surfactant and a polydextrose having an average degree of polymerization of at least about 10, wherein the nutritional emulsion has a first viscosity at 20° C. of less than about 300 cps and a second viscosity at a temperature of from 0° C. to 8° C. that is at least about 50 cps higher than the first viscosity.

A third embodiment of the present invention is a method of preparing a nutritional emulsion, said method comprising (a) forming an aqueous slurry, substantially free of fat, by combining a food grade surfactant with a polydextrose having an average degree of polymerization of at least about 10; (b) combining and homogenizing the aqueous slurry with fat and protein to form a nutritional emulsion having an aqueous phase comprising from about 10% to 100% by weight of the food grade surfactant and from about 10% to 100% by weight of the polydextrose, wherein the nutritional emulsion has a first viscosity of less than about 300 cps as measured at 20° C. and a second viscosity as measured at between about 0° C. and about 8° C. that is at least about 50 cps higher than the first viscosity. The resulting nutritional emulsion may be further characterized by the presence of a V-complex formed by the combination of some or all of the polydextrose and food grade surfactant in the aqueous phase.

The various embodiments of the present invention provide nutritional emulsions that have a lower viscosity during processing and storage, but also have a surprisingly higher viscosity when chilled. As a chilled beverage, the nutritional emulsions also have a surprisingly thick and creamy texture or mouthfeel.

### DETAILED DESCRIPTION OF THE INVENTION

Various embodiments of the present invention may include nutritional emulsions, and methods for making those emulsions, all of which may comprise selected V-complexes as defined herein and/or an aqueous phase comprising selected combinations of a polydextrose and a food grade surfactant. These and other essential or optional elements of the various embodiments are described in detail hereinafter.

The term “nutritional emulsion” as used herein, unless otherwise specified, means a room temperature emulsion comprising fat, protein, and carbohydrates, that is suitable for use as a sole, primary, or supplemental source of oral nutrition in a human. Such nutritional emulsions include classic emulsions (e.g., complex, water-in-oil, oil-in-water, etc.), suspensions (e.g., suspended solids), and combinations thereof. The nutritional emulsions are most typically oil-in-water emulsions having a continuous aqueous phase and a discontinuous oil phase.

Viscosity values as used herein, unless otherwise specified, are obtained using a Brookfield Viscometer (Model DV-II+) with a 62 spindle at room temperature (20° C.), or at the temperature so designated. The viscosity is measured by operating the viscometer at a spindle speed that is the highest speed possible to obtain a reading that is on scale. The measured viscosity values represent the ratio of shear stress to shear rate, expressed as dynes-second/cm², or poise, or more typically as centipoise (cps) or one hundredth of a poise.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

Any reference to singular characteristics or limitations of the present invention shall include the corresponding plural characteristic or limitation, and vice versa, unless otherwise specified.

Any combination of method or process steps as used herein can be performed in any order, unless otherwise specified.

The embodiments of the compositions and methods of the present invention may be substantially free of any specific ingredient described herein, provided that the remaining composition comprises all of the essential limitations as defined herein. In this context, the term “substantially free” means that the compositions may comprise less than a functional amount of the identified ingredient disclosed herein, typically less than about 1%, including less than about 0.5%, also including less than about 0.1%, and also including zero percents by weight of the identifed ingredient.

The embodiments of the compositions and methods of the present invention may comprise, consist of, or consist essentially of the essential elements of the invention described herein, as well as any additional or optional ingredients or components described herein or otherwise useful in a nutritional application.

The term “food grade surfactant” as used herein, unless otherwise specified, means the surfactant component of the carbohydrate-surfactant complexes (V-complexes) described herein.

### Product Form

The nutritional emulsion embodiments of the present invention are emulsions having a viscosity as measured at room temperature (20° C.) of less than about 300 cps, typically from about 10 cps to about 160 cps, and more typically from about 20 cps to about 70 cps.

Immediately prior to consumption, the nutritional emulsion may be cooled or chilled to a temperature of from about 0° C. to about 8° C., including from about 1° C. to about 6° C., and also including from about 2° to about 4° C., at which point the viscosity of the chilled nutritional emulsion increases by at least about 50 cps, including an increase of from about 100 to about 700 cps, and also including an increase of from about 150 cps to about 350 cps, above the corresponding room temperature viscosity.

The chilled nutritional emulsion, which will therefore have a viscosity higher than the nutritional emulsion at room temperature, will typically have a chilled viscosity of at least about 120 cps, including from about 120 cps to about 600 cps, also including from about 150 cps to about 450 cps, and also including from about 200 cps to about 400 cps.

The nutritional emulsions are typically in the form of aqueous emulsions, including milk-based (soy or cows milk) or other oil-in-water emulsions, most typically milk-based emulsions. The nutritional liquids may be formulated with sufficient kinds and amounts of nutrients to provide a potential sole, primary or supplemental source of nutrition, or to provide a specialized nutritional emulsion for use in individuals afflicted with specific diseases or conditions.

### V-Complex

The nutritional emulsion embodiments of the present invention may be characterized by the presence of a V-complex comprising a food grade surfactant in combination with a polydextrose having an average degree of polymerization of at least about 10. The V-complex may be formed prior to or during the manufacturing process, such as in accordance with the processing methods described herein.

The term “V-complex” as used herein, unless otherwise specified, refers to carbohydrate-surfactant complexes formed by a combination that is substantially free of fat and comprises a food grade surfactant and a polydextrose (i.e., α (1,4) linked glucose polymer) having an average degree of polymerization of at least about 10. In an aqueous liquid, the selected glucose polymers form left-handed, 6-residue helices with a hydrophobic core. Under appropriate processing conditions, this hydrophobic core traps the hydrophobic section of the food grade surfactant to form a carbohydrate-surfactant complex having a distinctive V-complex r-ray diffraction pattern. This type of complex is referred to herein as a V-complex.

The nutritional emulsions may be evaluated for the presence of the V-complex. This may be done indirectly by either measuring the viscosity change when the product is refrigerated or cooled as described herein, and or by evaluating the product by conventional x-ray diffraction methods for the presence of the V-complex. Such x-ray diffraction methods are described, for example, by J-L Jane and Robyt, J. (1984) Carbohydrate Research 132:105. Journal of Rheology—May 1998—Volume 42, Issue 3, pp. 507-525 Mercier, C., R. Charbonniere, J. Grebaut, and J. F. de La Guerivière.

Inclusion or formation of the V-complex in the nutritional emulsion affects the resulting rheology profile of the nutritional emulsion. The nutritional emulsion, with the V-complex in the aqueous phase of the emulsion, has a relatively low viscosity at room temperature (20° C.), but when chilled has a significantly higher viscosity as the temperature drop further facilitates the formation of the V-complex within the aqueous phase, which then imparts both viscosity and a creamy mouthfeel to the emulsion. The lower viscosity during manufacture allows for reduced processing or sterilization temperatures. This may reduce manufacturing costs as well as reduce the rate or extent of formation of undesirable Malliard reaction products in the finished product.

It has been found that the V-complex in the nutritional emulsions provides a creamy mouthfeel when consumed In this context, the term “creamy” means that the product has a mouthfeel similar to a nutritional emulsion having a higher fat content The nutritional emulsions are therefore especially useful when formulated as a low fat formulation since the V-complex compensates for the watery-mouthfeel commonly associated with reduced fat content in an emulsion.

The V-complex may be formed within the nutritional emulsions by methods described herein This typically involves combining the food grade surfactant with the polydextrose in a separate aqueous slurry, substantially free of fat, that is then used to form part or all of the aqueous phase of the emulsion. Thus, the selected the food grade surfactant and polydextrose may be dispersed in an aqueous slurry during processing, under conditions that melt and disperse the food grade surfactant throughout the aqueous slurry, and thereafter combined and homogenized with other fat and protein ingredients to form a nutritional emulsion.

It should be noted, however, that the nutritional emulsion may contain other surfactants in addition to the food grade surfactant in the aqueous phase, especially to help emulsify the oil component in the emulsion, but these oil phase surfactants do not form the desired V-complex with the polydextrose as described herein. Oil blends added to the nutritional emulsion typically contain from 1 to 6% surfactants by weight of the oil.

The term “substantially free of fat” as used herein means that the referenced material, either the aqueous phase of the nutritional emulsion or the aqueous slurry used in preparation of the nutritional emulsion, contains less than about 0.1%, including less than 0.05%, and also including zero percent by weight of fat. It is understood, however, that such exclusion does not apply to the food grade surfactant, which in the case of an acylglycerol could be considered a fat.

The aqueous slurry comprising the food grade surfactant and the selected carbohydrate are typically heated to melt the surfactants and mixed sufficiently to disperse or dissolve the surfactant and selected carbohydrate, to thus promote the interaction of those ingredients to form the desired V-complexes therefrom. The resulting v-complex slurry may then be added with other ingredients in accordance with conventional or otherwise known processing steps for manufacturing the desired nutritional emulsion. The aqueous slurry is most typically heated to a temperature above the melt point of the surfactant, which heat may be added in the form of a heated carbohydrate mixture added to the surfactant, with a subsequent melting of the surfactant in newly formed aqueous slurry.

When the nutritional emulsion is later cooled or chilled prior to consumption, conditions favor further formation of the V-complex, which results in a surprising increase in product viscosity and creamy mouthfeel. Because the resulting V-complexes are essentially tiny particles that can be digested by saliva enzymes, they impart a thick, creamy mouthfeel similar to that of a rich oil-in-water type emulsion, e.g., milk-based or other fat based emulsion, even when the nutritional emulsion contains relatively low fat levels (which should otherwise result in a thin, watery mouthfeel).

The nutritional emulsion embodiments of the present invention, however, are distinct from the many prior art compositions that merely comprise food grade surfactants and a polydextrose, but do not combine the latter two ingredients in the aqueous phase of an emulsion or otherwise form a V-complex in that aqueous phase. In other words, the mere inclusion of these two ingredients in a composition is not sufficient to achieve the desired viscosity benefit, unless they are also combined or otherwise complexed within the aqueous phase of the nutritional emulsion.

The polydextrose component of the aqueous phase or of the V-complex has an average degree of polymerization of at least about 10, including from about 20 to about 400, also including from about 40 to about 200, and also including from about 60 to about 100. For purposes of defining the inventions hereof, the terms “degree of polymerization” and “average degree of polymerization” are used interchangeably to mean an average degree of polymerization value. The degree of polymerization (DP) is an art recognized term referring to the number of glucose or monomer units in a polymer.

Suitable polydextrose for use herein may include any glucose polymer having the requisite degree of polymerization that is also safe for use in oral nutritional products. Especially useful are maltodextrins and starches.

Suitable maltodextrins for use herein are those that are safe for use in oral nutritional products and that also have the requisite DP value, non limiting examples of which include Maltrin® M040 (DE range 4-7), Maltrin® M050 (DE range 4-7), Maltrin® 070 (DE range 6-9), Maltrin® M440 (DE range 4-7), all available from Grain Processing Corporation, Muscatine, Iowa, USA. In this context, DE refers to the dextrose equivalent of the maltodextrin. DE values correlate with DP values in accordance with the equation DP=100/DE.

Starch suitable for use in forming the V-complex may include regular starches, modified starches such as cold water soluble starches, pregelatinized starches or acid thinned starches.

Food grade surfactants for use herein include those surfactants that are suitable for use in an oral nutritional and that comprise at least one hydrophobic moiety, typically a hydrocarbon carbon. Non limiting examples of such surfactants include mono- and diacylglycrol esters of one or more fatty acids having 12 or more croon atoms, including from 12 to 24 carbon atoms, and also including from 18 to 22 carbon atoms, specific non-limiting examples of which include lauric acid, myristic acid, palmitic acid, stearic acid, oleic acid, linoleic acid, linolenic acid, arachidonic acid, eicosapentaenoic acid, docosahexaenoic acid, and behenic acid. These acylglycerols and methods of preparing them are well known in the formulation arts, all of which may be used herein in preparation of the food grade surfactants for use in the nutritional emulsion embodiments and methods of the present invention.

Specific non-limiting examples of suitable acylglycerols include Myverol™ 18-06 monoacylglycerol (distilled monoglycerides from hydrogenated soybean oil—Foodpro Co., Dubai, United Arab Emirates), Dimodan S K-A and Dimodan R/D K-A (Danisco), and BFP 65 PLM (American Ingredients). Specific non-limiting examples of other suitable food grade surfactants for use herein include sodium stearoyl-2 lactylate (SSL), sucrose esters, diacetl tartaric acid esters, and combinations thereof.

Other non-limiting examples of suitable food grade surfactants are described in U.S. Pat. No. 5,645,856, which descriptions are incorporated herein by reference. Non limiting examples of such surfactants include glyceryl mono-/di-caprylate, glyceryl mono-di-caprylate/caprylate, glyceryl mono-caprylate, glyceryl mono-stearate, glyceryl mono-di-ricinoleate, glyceryl caprylate/caprylate, glyceryl monooleate), glyceryl dilaurate, glyceryl mono-oleate, distilled monoglycerides from sunflower oil, and combinations thereof.

Other suitable food grade surfactants include acetic, succinic, lactic, citric and/or tartaric esters of mono- and/or di-glycerides of fatty acids, e.g., distilled acetylated monoglycerides, caprylic/capric diglyceryl succinate, mono/di-succinylated monoglycerides, glyceryl stearate citrate, glyceryl monostearate/citrate/lactate, diacetyl tartaric esters of monoglycerides, and combinations thereof.

The amount of acylglycerols or other food grade surfactants for use in the nutritional emulsions should be sufficient to form the V-complex within the aqueous phase of the emulsions. Such amounts may comprise at least about 0.003%, including from about 0.1 to about 5%, also including from about 0.2 to about 1%, by weight of the nutritional emulsion. It should be noted, however, that the nutritional emulsion may further comprise additional food grade surfactants for purposes other than forming the V-complex, for example as emulsifying agents for the nutritional emulsion or components thereof.

The amount of the selected polydextrose for use in the nutritional emulsions should be sufficient to form the V-complex within the aqueous phases of the emulsions. Such amounts may comprise at least about 0.5% including from about 0.75 to about 20%, also including from about 1 to about 5%, and also including from about 1.5 to about 3.5% by weight of the nutritional emulsion. It should be noted, however, that the nutritional emulsion may further comprse additional starch, maltodextrins, or other carbohydrates, including those having average DP values below about 10 as well as those having DP values above about 10, including those having DP values from about 10 to about 400.

The resulting weight ratio of the selected polydextrose to the food grade surfactant component of the formed complex may vary depending upon the selected formulation, including the selected carbohydrates and surfactants in the V-complex. Such ratios most typically range up to about 50:1, including from about 30:1 to about 1:1 and also including from about 10:1 to about 5:1.

### Macronutrients

The nutritional emulsion embodiments of the present invention comprise fat, protein, and carbohydrate macronutrients, all in addition to or inclusive of polydextrose and food grade surfactant components of the aqueous phase or V-complex as described herein Any source of such nutrients that is known or otherwise suitable for use in an oral nutritional product is also suitable for use herein, provided that such nutrients are also compatible with the other selected ingredients in the formulation.

Although concentrations or amounts of each macronutrient may vary depending upon the nutritional needs of the intended user, such concentrations or amounts most typically fall within one of the following embodied ranges (inclusive of the components of the polydextrose and food grade surfactant or V-complex).

| | Embodiments | | |
|---|---|---|---|
| Macronutrient | A | B | C |
| Carbohydrate¹ - % total calories | 10-85 | 20-60 | 40-60 |
| Fat² - % total calories | 10-85 | 10-50 | 15-35 |
| Protein - % total calories | 5-80 | 10-30 | 15-25 |
| Carbohydrate¹ g/100 ml | 1-40 | 4-30 | 10-20 |
| Fat² g/100 ml | 0.2-30 | 0.5-15 | 1-5 |
| Protein g/100 ml | 0.5-30 | 1-15 | 2-10 |

¹Includes polydextrose component of the aqueous phase or V-complex
²Includes food grade surfactants of the aqueous phase or V-complex

Non-limiting examples of suitable fat sources for use herein may include coconut oil, fractionated coconut oil, soy oil, corn oil, olive oil, safflower oil, high oleic safflower oil, MCT oil (medium chain triglycerides), sunflower oil, high oleic sunflower oil, palm and palm kernel oils, palm olein, canola oil, marine oils, cottonseed oils, and combinations.

Non-limiting examples of suitable carbohydrate sources for use herein may include hydrolyzed or modified starch or cornstarch, glucose polymers, corn syrup, corn syrup solids, rice-derived carbohydrate, glucose, fructose, lactose, high fructose corn syrup, indigestible oligosaccharides (e.g., fructooligosaccharides), honey, sugar alcohols (e.g., maltitol, erythritol, sorbitol), and combinations thereof.

Suitable protein sources for use herein include hydrolyzed, partially hydrolyzed or non-hydrolyzed proteins or protein sources, which may be derived from any known or otherwise suitable source such as milk (e.g., casein, whey), animal (e.g., meat, fish), cereal (e.g., rice, corn), vegetable (e.g., soy), or combinations thereof non-limiting examples of such proteins include milk protein isolates, casein protein isolates, milk protein concentrate, whole cows milk, partially or completely defatted milk, soy protein isolates, and so forth.

The nutritional emulsions may also be formulated as low fat emulsions comprising from about 0.1 to about 2.0 grams, including from about 0.5 to about 1.5 grams, and also including from about 0.75 to about 1.1 grams, of fat per 100 ml of the emulsion, and/or from about 1% to about 20%, including from about 3% to about 10%, and also including from about 4% to about 8%, fat as a percentage of total calories.

The nutritional emulsions may also be formulated as a low calorie product that comprises from about 50 to about 200 kcals, including from about 75 to about 170, and also including from about 99 to about 140 kcal, per 240 ml of the emulsion.

### Optional Ingredients

The nutritional emulsion embodiments of the present invention may further comprise other optional components that may modify the physical, chemical, aesthetic or processing characteristics of the products or serve as pharmaceutical or additional nutritional components when used in the targeted population. Many such optional ingredients are known or otherwise suitable for use in other nutritional products and may also be used in the compositions herein, provided that such optional ingredients are safe and effective for oral administration and are compatible with the essential and other ingredients in the selected product form.

Non-limiting examples of such optional ingredients include preservatives, antioxidants, other additional emulsifying agents, buffers, pharmaceutical actives, additional nutrients as described herein, sweeteners including artificial sweeteners (e.g., saccharine, aspartame, acesulfame K, sucralose) colorants, flavors, thickening agents and stabilizers, and so forth.

The nutritional emulsion embodiments of the present invention may further comprise any of a variety of other vitamins or related nutrients, non-limiting examples of which include vitamin A, vitamin D, vitamin E, vitamin K, thiamine, riboflavin, pyridoxine, vitamin B12, carotenoids, niacin, folic acid, pantothenic acid, biotin, vitamin C, choline, inositol, salts and derivatives thereof, and combinations thereof.

The nutritional emulsion embodiments may further comprise any of a variety of other additional minerals, non-limiting examples of which include calcium, phosphorus, magnesium, iron, zinc, manganese, copper, sodium, potassium, molybdenum, chromium, selenium, chloride, and combinations thereof.

### Method of Manufacture

The nutritional emulsion embodiments of the present invention may be prepared in accordance with the method embodiments of the present invention. These method embodiments may comprise the following steps:
(a) forming an aqueous slurry, substantially free of fat, by combining a food grade surfactant with a polydextrose having an average degree of polymerization of at least about 10;
(b) combining and homogenizing the aqueous slurry with fat and protein to form a nutritional emulsion having an aqueous phase comprising from about 10% to 100% by weight of the food grade surfactant and from about 10% to 100% by weight of the polydextrose, wherein the nutritional emulsion has a first viscosity of less than about 300 cps as measured at 20° C. and a second viscosity as measured at between about 0° C. and about 8° C. that is at least 50 cps higher than the first viscosity.

A second method embodiment of the present invention may comprise the following steps:
(a) forming an aqueous slurry, substantially free of fat, by combining a food grade surfactant with a polydextrose having an average degree of polymerization of at least about 10;
(b) combining and homogenizing the aqueous slurry with fat and protein to form a nutritional emulsion having an aqueous phase comprising a V-complex containing at least some of the food grade surfactant complexed with the polydextrose, most typically from about 10% to 100% by weight of each, wherein the nutritional emulsion has a first viscosity of less than about 300 cps as measured at 20° C. and a second viscosity as measured at between about 0° C. and about 8° C. that is at least 50 cps higher than the first viscosity.

The above method embodiments may be modified to also include the various elements or features of the nutritional emulsion embodiments as described herein.

The method embodiments typically further comprises providing physical shear or mixing, while also heating or supplying heat, to the aqueous slurry sufficient to melt the food grade surfactant and solubilize the polydextrose, and thus disperse the two ingredients throughout the aqueous slurry.

The method embodiments may further comprise packaging the resulting nutritional emulsion in a suitable container The method may also further comprise exposing the packaged nutritional emulsion to retort sterilization to produce a retort packaged nutritional emulsion having a first and second viscosity as defined herein. Retort sterilization is a process step well known to one of ordinary skill in the formulation art, which typically involves high temperature treatment of a packaged liquid nutritional The nutritional emulsion may also be aseptically packaged rather than retort sterilized.

The method embodiments of the present invention may further comprise the following steps, or instructions to a user or consumer to perform the following steps, wherein such steps may include 1) cooling or refrigerating the nutritional emulsion, or packaged nutritional emulsion, prior to use, or 2) cooling or refrigerating the nutritional emulsion, or the retort packaged nutritional emulsion, to a temperature sufficient to increase the viscosity of the emulsion by at least about 50 cps, which may include an increase of from about 100 to about 700 cps, and may also include an increase of from about 150 cps to about 350 cps, above the first viscosity as measured at 20° C. To achieve the desired viscosity increase, the nutritional emulsion is most typically cooled to between about 0° C. to about 8° C., which may include a temperature of from about 1° C. to about 6° C., and may also include a temperature of from about 2° to about 4° C.

The chilled nutritional emulsion, which therefore has a surprisingly higher viscosity than the nutritional emulsion at room temperature, typically has a chilled viscosity of at least about 120 cps, including from about 120 cps to about 600 cps, including from about 150 cps to about 450 cps, and also including from about 200 cps to about 400 cps.

When the nutritional emulsion is then cooled or chilled prior to consumption, conditions favor further formation or development of the V-complex, which results in a surprising increase in product viscosity and creamy texture. Because the resulting V-complexes are essentially tiny particles that can be digested by saliva enzymes they impart a thick, creamy mouthfeel, even en there may be a low fat level in the nutritional emulsion.

The nutritional emulsions may be manufactured by any conventional or otherwise known method for making nutritional emulsions, most typically for making nutritional emulsions or milk based emulsions, except that the formulation must include or accommodate the essential process steps described herein for the formation of the specified aqueous phase or V-complex. Most typically, two or more separate slurries are prepared, one of which must be an aqueous slurry that is substantially free of fat and comprises the food grade surfactant in combination with the selected maltodextrin or starch. Other slurries may include a protein in fat/oil slurry (e-g., protein, fat, emulsifier or surfactant in addition to the food grade surfactant in the aqueous slurry), a protein in water slurry (e.g., protein, water), and additional carbohydrate slurries. The multiple slurries are eventually combined together in a blend tank, subjected to ultra high temperature processing, homogenized, infused with added vitamins or other optional ingredients, diluted with water as appropriate. The resulting nutritional emulsions may then be aseptically packaged or otherwise filled into retort stable packages and then subjected to retort sterilization.

The embodiments of the present invention may, of course, be carried out in other ways than those set forth herein without departing from the spirit and scope of the invention. The present embodiments are, therefore, to be considered in all respects as illustrative and not restrictive and that all changes and equivalents also come within the description of the present invention.

### EXAMPLES

The following examples represent specific embodiments within the scope of the present invention, each of which is given solely for the purpose of illustration and is not to be construed as limitations of the present invention, as many variations thereof are possible without departing from the spirit and scope of the invention. All exemplified amounts are weight percentages based upon the total weight of the composition, unless otherwise specified.

### Examples 1-3

Nutritional emulsion embodiments of the present invention are prepared by combining the following ingredients in accordance with the method embodiments of the present invention.

| | Example 1 | Example 2 | Example 3 |
|---|---|---|---|
| | Amount | Amount | Amount |
| Ingredient | (kg) | (kg) | (kg) |
| Protein in water slurry (PIW) | | | |
| Water | 373.37 | 373.37 | 373.37 |
| Milk protein isolate | 60.66 | 60.66 | 60.66 |
| Whey protein concentrate | 4.00 | 4.00 | 4.00 |
| Carbohydrate slurry (CHO) | | | |
| Water | 130.60 | 130.60 | 130.60 |
| Potassium Citrate | 3.44 | 3.44 | 3.44 |
| Na Citrate | 1.09 | 1.09 | 1.09 |
| Ultra Trace Mineral/Trace | 0.544 | 0.544 | 0.544 |
| Mineral premix | | | |
| Potassium Iodide | 0.00015 | 0.00015 | 0.00015 |
| Myverol ™ 18-06 | 2 | 3 | 2 |
| (Monoacylglycerols) | | | |
| Maltodextrin DE 1 (DP 100) | 20 | 30 | 40 |
| Micronized tricalcium phosphate | 2.22 | 2.22 | 2.22 |
| Mg Phosphate Dibasic | 2.57 | 2.57 | 2.57 |
| Fructooligosaccharide powder | 8.70 | 8.70 | 8.70 |
| Soy Fiber | 4.00 | 4.00 | 4.00 |
| Apple Fiber | 4.00 | 4.00 | 4.00 |
| Fructose | 23.20 | 23.20 | 23.20 |
| Sucrose | 16.20 | 16.20 | 16.20 |
| Protein in Fat/Oil (PIF) | | | |
| Soy Oil | 14.44 | 14.44 | 14.44 |
| Canola Oil | 4.81 | 4.81 | 4.81 |
| Corn Oil | 6.08 | 6.08 | 6.08 |
| Soy Lecithin | 1.77 | 1.77 | 1.77 |
| Vitamin Premix | 0.135 | 0.135 | 0.135 |
| Carrageenan | 0.300 | 0.300 | 0.300 |
| SPI-Supro 1610 | 6.85 | 6.85 | 6.85 |
| (Soy Protein Isolates) | | | |
| Vitamin Addition/Dilution Water | | | |
| Water | 129.56 | 129.56 | 129.56 |
| Ascorbic Acid | 0.780 | 0.780 | 0.780 |
| Vitamin Premix | 0.313 | 0.313 | 0.313 |
| Natural Flavors | 4.30 | 4.30 | 4.30 |

The individual CHO, PIW, and PIF slurries are prepared separately For each individual slurry, the ingredients are mixed together for that slurry under temperature and shear appropriate for the selected materials, after which the different slurries are combined in a blend tank, subjected to ultra high temperature treatment (UHT) and then homogenized at about 3000 psi. Vitamins are then added to the homogenized mixture The resulting mixture is diluted with water as needed to achieve the desired concentrations. The final mixture is then filled into retort stable 8 oz plastic bottles and then subjected to retort sterilization The package nutritional emulsion is characterized by the presence of an aqueous phase having a V-complex comprising the food grade surfactant complexed with the selected maltodextrin or starch component, or by the presence within the aqueous phase of at least about 10% by weight of the food grade surfactant and at least about 10% by weight of the polydextrose (maltodextrn or starch). The retort-packaged products are then labeled with instruction to cl or refrigerate prior to use.

The nutritional emulsions are removed from the package and tested for the presence of the v-complex.

Each of the resulting retort packaged nutritional emulsions (Examples 1-3) has a viscosity as measured at 20° C. of between about 20 and 160 cps. Each is refrigerated to between 0° and 8° C. and develops a chilled viscosity of between about 220 and about 350 cps that is then consumed as chilled. The chilled emulsion has a thick creamy mouthfeel.

### Examples 4-6

Examples 1-3 are repeated and, instead of retort sterilization, the resulting nutritional emulsions are aseptically packaged into 8 oz plastic containers. The packaged nutritional emulsions are characterized by the presence of an aqueous phase having a V-complex comprising the food grade surfactant complexed with the selected maltodextrin or starch component, or by the presence within the aqueous phase of at least about 10% by weight of the food grade surfactant and at least about 10% by weight of the polydextrose (maltodextrin or starch). The aseptically packaged products are then labeled with instruction to cool or refrigerate prior to use.

Each of the resulting retort packaged nutritional emulsions (Examples 1-3) has a viscosity as measured at 20° C. of between about 20 and 160 cps. Each is refrigerated to between 0° and 8° C. and develops a chilled viscosity of between about 220 and about 350 cps that is then consumed as chilled. The chilled emulsion has a thick, creamy mouthfeel.

What is claimed is:

1. Nutritional emulsions comprising fat, protein and carbohydrate, which includes a V-complex comprising a food grade surfactant complexed with a polydextrose having an average degree of polymerization of at least about 10; wherein the nutritional emulsions have a first viscosity at 20° C. of less than about 300 cps and a second viscosity at a temperature of from 0° C. to 8° C. that is at least about 50 cps higher than said first viscosity.

2. A nutritional emulsion according to claim 1 wherein the food grade surfactant is a monoacylglyerol.

3. A nutritional emulsion according to claim 1 wherein polydextrose comprises maltodextrin.

4. A nutritional emulsion according to claim 1 wherein the V-complex comprises a C12 or higher monoacylglycerol in combination with maltodextrin having an average degree of polymerization of from about 20 to about 400.

5. A nutritional emulsion according to claim 1 wherein the nutritional emulsion comprises from about 1% to about 5% by weight of the polydextrose, and from about 0.001% to about 5% by weight of the food grade surfactant.

6. A nutritional emulsion according to claim 1 wherein the nutritional emulsion has a weight ratio of the polydextrose to the food grade surfactant of from about 50:1 to about 1:1.

7. A nutritional emulsion according to claim 1, wherein the nutritional emulsion is a retort-packaged milk-based emulsion comprising, as a percentage of total calories, from about 10 to about 85% fat, from about 5 to about 80% protein, and from about 10 to about 85% by weight of carbohydrate.

8. A nutritional emulsion according to claim 1 wherein the nutritional emulsion contains from about 0.1 to about 2.0 grams of fat per 100 ml of the emulsion.

9. A nutritional emulsion according to claim 1 wherein the nutritional emulsion has a first viscosity at 20° C. of from about 10 to about 160 cps and a second viscosity at a temperature of from 0° C. to 8° C. that is from about 100 to about 350 cps higher than said first viscosity.

10. Nutritional emulsions comprising fat, protein and carbohydrate, including an aqueous phase comprising a food grade surfactant and a polydextrose having an average degree of polymerization of at least about 10, wherein the nutritional emulsions have a first viscosity at 20° C. of less than about 300 cps and a second viscosity at a temperature of from 0° C. to 8° C. that is at least about 50 cps higher than the first viscosity.

11. A nutritional emulsion according to claim 10 wherein the food grade surfactant is a monoacylglyerol.

12. A nutritional emulsion according to claim 10 wherein the polydextrose comprises maltodextrin.

13. A nutritional emulsion according to claim 10, wherein the aqueous phase comprises a C12 or higher monoacylglycerol and a maltodextrin having an average degree of polymerization of from about 20 to about 400.

14. A nutritional emulsion according to claim 10 wherein the nutritional emulsion comprises from about 0.5% to about 20% by weight of the polydextrose, and from about 0.1% to about 5% by weight of the food grade surfactant.

15. A nutritional emulsion according to claim 10 wherein the nutritional emulsion has a weight ratio of the polydextrose to the food grade surfactant of from about 50:1 to about 1:1.

16. A nutritional emulsion according to claim 10, wherein the nutritional emulsion is a retort-packaged milk-based emulsion comprising, as a percentage of total calories, from about 10 to about 85% fat, from about 5 to about 80% protein, and from about 10 to about 85% by weight of carbohydrate.

17. A nutritional emulsion according to claim 10 wherein the nutritional emulsion contains from about 0.1 to about 2.0 grams of fat per 100 ml of the emulsion.

18. A nutritional emulsion according to claim 10 wherein the nutritional emulsion has a first viscosity at 20° C. of from about 10 to about 160 cps and a second viscosity at a temperature of from 0° C. to 8° C. that is from about 100 to about 350 cps higher than said first viscosity.
